(19) United States
(12) Patent Application Publication
(10) Pub. No.: US 2026/0156090 A1
(43) Pub. Date: Jun. 4, 2026

(54) METHOD, SERVER, AND USER TERMINAL FOR PROVIDING SELECTED DEPENDENT MESSAGE

(71) Applicant: KAKAO CORP., Jeju-si (KR)

(72) Inventor: Bo Hyeon LIM, Seongnam-si (KR)

(21) Appl. No.: 19/400,834

(22) Filed: Nov. 25, 2025

(30) Foreign Application Priority Data
Dec. 2, 2024 (KR) 10-2024-0176718

(51) Int. Cl. H04L 51/04; H04L 51/216

(52) U.S. Cl. CPC H04L 51/04; H04L 51/216

(57) ABSTRACT

A method for providing a selected dependent message by a server may include providing, to a user terminal, a chat room in which messages are generated, at least some of the messages being distinguished as chat messages and dependent messages. The dependent messages may be dependent on one of the chat messages that serves as a base message. When at least one of the chat messages is a target chat message satisfying a predetermined condition, the method may also include providing, through the chat room, a selected dependent message corresponding to the target chat message.

### CROSS-REFERENCE TO RELATED APPLICATION

This application claims priority to and the benefit of Korean Patent Application No. 10-2024-0176718 filed on Dec. 2, 2024, the disclosure of which is incorporated herein by reference in its entirety.

### BACKGROUND

### Technical Field

The present disclosure relates to a method for providing a selected dependent message by a server through a chat room.

### Description of Related Technology

Recently, popular comments that have received many “likes” or expressions of sympathy from users have been provided separately from general comments in chat rooms, posts, and news articles. Such a feature enables users to easily identify comments of interest and improves user satisfaction with the content.

### SUMMARY

One aspect is to provide, through a chat room, a selected dependent message among dependent messages for a specific chat message, thereby facilitating identification of reactions from other users to the specific chat message.

Another aspect is to provide a chat room in which many-to-one conversations mainly occur between a specific person and a plurality of participants, thereby facilitating identification of reactions from the plurality of participants.

Another aspect is a method for providing a selected dependent message by a server that includes: providing, to a user terminal, a chat room in which messages are generated, at least some of the messages being distinguished as chat messages and dependent messages, wherein the dependent messages are dependent on one of the chat messages that serves as a base message; and when at least one of the chat messages is a target chat message satisfying a predetermined condition, providing, through the chat room, a selected dependent message corresponding to the target chat message.

In one embodiment of the present disclosure, the dependent messages may be threaded messages including content written by creators of the dependent messages.

In one embodiment of the present disclosure, the method may further include receiving, from the user terminal, an interaction with at least one of the target chat message and the selected dependent message; and providing, to the user terminal, a thread comprising the target chat message and the selected dependent message through an object that is distinct from the chat room.

In one embodiment of the present disclosure, the predetermined condition may be associated with whether the user terminal has viewed the thread.

In one embodiment of the present disclosure, the predetermined condition may be associated with the number of viewers of the thread.

In one embodiment of the present disclosure, the method may further include, in response to determining that the predetermined condition associated with the number of viewers is satisfied, providing information on the number of viewers through the chat room.

In one embodiment of the present disclosure, the method may further include, in response to determining that a new dependent message is generated for the target chat message, providing information associated with the generation of the new dependent message through the chat room.

In one embodiment of the present disclosure, the predetermined condition may be associated with generation of a new dependent message for the target chat message.

In one embodiment of the present disclosure, the predetermined condition may be associated with an activity level of the dependent messages for the target chat message, and the activity level may be based on at least one of (i) the number of the dependent messages for the target chat message, and (ii) a time at which each of the dependent messages for the target chat message is generated.

In one embodiment of the present disclosure, the predetermined condition may be associated with reactions to the target chat message.

In one embodiment of the present disclosure, the predetermined condition may be associated with a reaction index of an account that generated the target chat message, and the reaction index may be based on at least one of (i) dependent messages for chat messages previously generated by the account and (ii) reactions to the chat messages previously generated by the account.

In one embodiment of the present disclosure, the predetermined condition may be associated with whether different permissions to generate messages are assigned to participants in the chat room.

In one embodiment of the present disclosure, the predetermined condition may be associated with a permission of the account that generated the chat message.

In one embodiment of the present disclosure, the selected dependent message may be at least one of the dependent messages for the target chat message, and the selected dependent message may be determined based on reactions to the dependent messages for the target chat message.

In one embodiment of the present disclosure, the chat room may be classified as a first-type chat room configured to provide a dependent message corresponding to a chat message or a second-type chat room not configured to provide a dependent message corresponding to a chat message, and the method may further include receiving information on a type of the chat room from an operator terminal of the chat room.

Another aspect is a server for providing a selected dependent message that includes a memory storing instructions, and a processor configured to execute instructions to: provide, to a user terminal, a chat room in which messages are generated, at least some of the messages being distinguished as chat messages and dependent messages, wherein the dependent messages are dependent on one of the chat messages that serves as a base message; and when at least one of the chat messages is a target chat message satisfying a predetermined condition, provide, through the chat room, a selected dependent message corresponding to the target chat message;

Another aspect is a method for displaying a selected dependent message by a user terminal that includes: displaying a chat room including messages, at least some of the messages being distinguished as chat messages and dependent messages, wherein the dependent messages are dependent on one of the chat messages that serves as a base message; and when at least one of the chat messages is a target chat message satisfying a predetermined condition, displaying, through the chat room, a selected dependent message for the target chat message.

In one embodiment of the present disclosure, the method may further include: receiving an interaction with at least one of the target chat message and the selected dependent message; and displaying a thread comprising the target chat message and the selected dependent message through an object that is distinct from the chat room.

Another aspect is a user terminal for displaying a selected dependent message that includes a memory storing instructions, and a processor configured to execute instructions to: display a chat room including messages, at least some of the messages being distinguished as chat messages and dependent messages, wherein the dependent messages are dependent on one of the chat messages that serves as a base message; and when at least one of the chat messages is a target chat message satisfying a predetermined condition, display, through the chat room, a selected dependent message for the target chat message.

### BRIEF DESCRIPTION OF THE DRAWINGS

FIG. 1 is a diagram illustrating an example of a network environment according to one embodiment of the present disclosure.

FIG. 2 is a flowchart illustrating a method for providing a selected dependent message by a server according to the present disclosure.

FIGS. 3 to 7 illustrate screens showing how a user terminal displays a selected dependent message according to one embodiment of the present disclosure.

FIG. 8 is a flowchart illustrating a method for displaying a selected dependent message by a user terminal according to an embodiment of the present disclosure.

### DETAILED DESCRIPTION

A method of providing threaded messages in the form of comments or replies to an original message has recently been introduced in chat rooms. This threading feature enables the flow of a conversation to be better understood by collectively displaying responses to a specific message.

However, when various types of threaded messages in a chat room are displayed together with a base message, an excessive number of messages may appear on a single screen, making it difficult to locate a specific message. Accordingly, there has been a growing need for methods that enable chat room operators to efficiently display threaded messages of user interest while minimizing congestion in the conversation flow.

Hereinafter, embodiments disclosed in this specification will be described in detail with reference to the attached drawings. Regardless of the reference numerals, identical or similar components are denoted by the same reference numerals, and redundant descriptions thereof will be omitted. In addition, when describing the embodiments disclosed in this specification, if it is determined that a detailed description of related known technology may obscure the subject matter of the embodiments disclosed herein, such detailed description will be omitted.

Terms including ordinal numbers, such as first, second, and the like., may be used to describe various components, but the components are not limited by the terms. The above terms are merely used to distinguish one component from another.

Singular expressions include plural expressions unless the context clearly indicates otherwise.

In this application, the respective steps described may be performed in any suitable order, unless a particular order is explicitly required by the context or a specific causal relationship.

In this application, terms such as “include” or “have” are intended to specify the presence of a feature, number, step, operation, component, part, or combination thereof described in the specification, but should be understood not to exclude the presence or addition of one or more other features, numbers, steps, operations, components, parts, or combinations thereof.

Hereinafter, the present disclosure will be described with reference to the attached drawings.

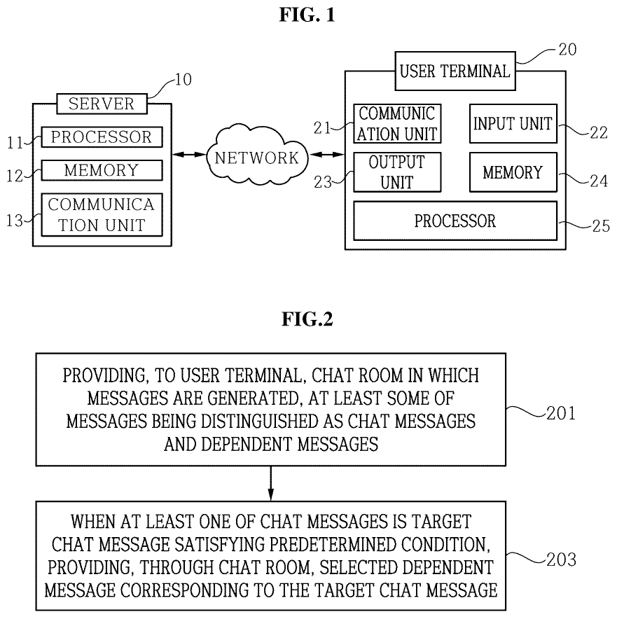

FIG. 1 is a diagram illustrating an example of a network environment according to one embodiment of the present disclosure.

The network environment illustrated in FIG. 1 according to one embodiment of the present disclosure may include a server 10 and a user terminal 20. The network environment may include at least one user terminal 20 that is connected to the server 10 via a network. In FIG. 1, a user terminal 20 is illustratively shown as an example of a user device.

The user terminal 20 denotes a terminal configured for use by a user who logs in with a user account registered in the server 10.

Hereinafter, for convenience of explanation, the user terminal 20 will be described as displaying chat messages and a selected dependent message through a chat room. However, the present disclosure is not limited to the functions that may be performed by the user terminal 20.

The network is not limited by a specific communication scheme and may include communication networks (for example, a mobile communication network, a wired Internet, a wireless Internet, or a broadcasting network) as well as short-range wireless communication.

In the present disclosure, the server 10 may be configured to transmit and receive information through communication with the user terminal 20 via a network. The server 10 may be implemented as one or more computer devices that provide commands, codes, files, content, or services.

The server 10 may include a processor 11, a memory 12, and a communication unit 13.

The processor 11 controls the overall operation of the memory 12 and the communication unit 13 to determine whether a chat message satisfies a predetermined condition.

The memory 12 functions as a storage medium and may store a plurality of application programs executed on the server 10, as well as data and commands for the operation of the server 10. In one embodiment, the memory 12 may store an application configured to provide a selected dependent message through a chat room.

The memory 12 may be provided in the form of various storage devices, such as ROM, RAM, flash drives, or hard drives, or may be provided as web storage.

The communication unit 13 may communicate with the user terminal 20 via a network in a wired/wireless manner.

The server 10 of the present disclosure may provide a selected dependent message to the user terminal 20 through a chat room.

In the present disclosure, the server 10 may provide, to the user terminal 20, a chat room where messages are generated, at least some of the messages being distinguished as chat messages or dependent messages. A dependent message may be dependent on one of the chat messages that serves as a base message. When a target chat message, which is at least one of the chat messages, satisfies a preset condition, the server 10 may provide a selected dependent message corresponding to the target chat message through a chat room.

A chat message refers to a message independently generated in a chat room and posted without being dependent on other messages in the chat room. The chat message is generally the most basic form of message in a chat room and may be posted on the main screen of the chat room.

Meanwhile, a dependent message refers to a message generated as a response or reaction to a specific chat message. The dependent message is dependent on a pre-generated chat message and may be used to express an additional explanation, comment, or reaction thereto. A chat message having a dependent message may be referred to as a base message.

A thread message may be a type of dependent message. For example, the threaded message may be a reply message, a comment message, or the like to a chat message serving as a base message.

The target chat message means a message that is subject to determination as to whether a predetermined condition is satisfied from among messages generated in the chat room. Any chat message displayed in the chat room may be a targeted chat message. In this case, the server 10 may determine whether all chat messages displayed in the chat room satisfy a predetermined condition. When a target chat message satisfies the predetermined condition, a selected dependent message may be displayed together with the target chat message.

The predetermined condition associated with chat messages refer to a condition for displaying the selected dependent message. The server 10 may identify a chat message satisfying the predetermined condition among a plurality of chat messages generated in a chat room.

For example, the predetermined condition may be associated with whether a user has viewed a thread including the target chat message, the number of viewers of the thread, whether a new dependent message is generated for the target chat message, an activity level of dependent messages for the target chat message (that is, the number of dependent messages added in real time), the number of reactions received by the target chat message, the reaction index of an account that generated the target chat message, or whether different permissions to generate messages (dependent messages) are assigned to participants in the chat room.

A selected dependent message refers to a dependent message having the highest level of reaction among the dependent messages dependent on the target chat message. Specifically, a plurality of participants in the chat room may view a thread including the target chat message and the selected dependent message and may generate reactions to the target chat message or the selected dependent message. Reactions may include various types of emotional information, such as positive, negative, surprise, or sadness. A dependent message having the highest number of reactions or the highest number of positive reactions may be determined as the selected dependent message.

Providing a selected dependent message corresponding to the target chat message means providing the selected dependent message together with the target chat message. Specifically, chat messages may be displayed through a chat room, and dependent messages may be displayed through a thread. However, when the target chat message satisfies a predetermined condition, a selected dependent message may be displayed together with or around the target chat message.

The user terminal 20 includes a terminal that displays chat messages and selected dependent messages through a chat room. The user terminal 20 may include a communication unit 21, an input unit 22, an output unit 23, a memory 24, and a processor 25.

The communication unit 21 may communicate with the server 10 or other terminals in a wired/wireless manner.

The input unit 22 may receive various types of information through a user's operation and input actions. The input unit 22 may be a touch screen module, a keyboard, a mouse, a button, a camera, a stylus, a microphone, and the like.

The user terminal 20 may receive the user's interaction through the input unit 22. The term “interaction” refers to an operation in which the user manipulates the input unit 22 to input information reflecting the user's selection or intention into the user terminal 20. For example, the interaction may include touching a touchscreen, clicking a mouse, typing on a keyboard, inputting sound through a microphone, capturing an image through a camera, recognizing motion through a motion sensor, or the like.

The output unit 23 may output various types of information. The output unit 23 may include a display device, a speaker, a vibration generating device, a tactile feedback device, or the like. In some cases, the output unit 23 may be a device, such as a Bluetooth earphone, that is connected to the user terminal 20 through wired or wireless communication (for example, short-range wireless communication such as Bluetooth) to receive and output signals.

The memory 24 functions as a storage medium and may store a plurality of application programs executed on the user terminal 20, as well as data and commands for the operation of the user terminal 20. The memory 24 may be provided in the form of various storage devices, such as ROM, RAM, flash drives, or hard drives, or may be provided as web storage. In one embodiment, the memory 24 may store chat messages and dependent messages generated by participant terminals of the chat room.

The processor 25 may control the overall operation of the communication unit 21, the input unit 22, the output unit 23, and the memory 24 to execute an application including a function for providing a selected dependent message through a chat room.

In the present disclosure, the user terminal 20 may display a chat room including messages, at least some of the messages being distinguished as chat messages or dependent messages. A dependent message may be dependent on one of the chat messages that serves as a base message. When a target chat message, which is at least one of the chat messages, satisfies a predetermined condition, the user terminal 20 may display, through a chat room, a selected dependent message together with the target chat message.

Hereinafter, an embodiment of a method by which the server 10 of the present disclosure provides a selected dependent message will be described with reference to FIGS. 2 to 7.

FIG. 2 is a flowchart illustrating a method in which the server 10 of the present disclosure provides a selected dependent message.

In operation 201, the server 10 provides, to the user terminal 20, a chat room in which messages are generated, at least some of the messages being distinguished as chat messages and dependent messages.

A dependent message may be dependent on one of the chat messages that serves as a base message. As an example, a dependent message may be a threaded message that includes content generated by the author of the dependent message. A dependent message may be provided through a thread that is displayed in response to an interaction with a chat message. However, in some cases, a dependent message that satisfies a predetermined condition may be provided through the chat room.

The operator terminal of the chat room may request the server 10 to create a chat room. The chat rooms may be classified as a first-type chat room configured to provide dependent messages for chat messages or a second type not configured to provide dependent messages for chat messages.

Specifically, the first-type chat room may be configured to provide, through the chat room, not only chat messages but also a selected dependent message for a target chat message. However, the second-type chat room may provide only chat messages through the chat room and provide a dependent message for a chat message through a thread displayed in response to an interaction with the chat message. That is, in the second-type chat room, a selected dependent message (for example, a dependent message having the highest number of positive reactions) may not be provided through the chat room.

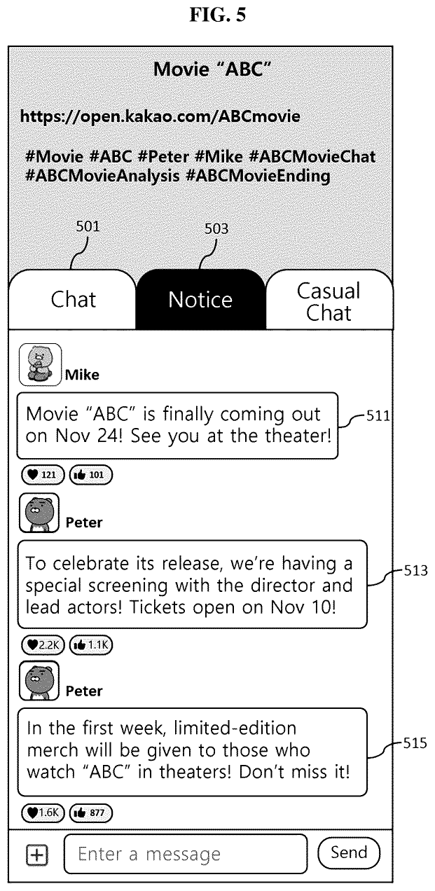

When an operator terminal creates a chat room, the server 10 may receive information on the type of the chat room from the operator terminal. Hereinafter, it will be described on the assumption that all chat rooms except for the one shown in FIG. 5 are first-type chat rooms.

In operation 203, when at least one of the chat messages is a target chat message satisfying a predetermined condition, the server 10 provides a selected dependent message corresponding to the target chat message through the chat room.

The server 10 may determine whether the target chat message satisfies the predetermined condition. The target chat message may be a chat message subject to whether a predetermined condition is satisfied.

The predetermined condition associated with chat messages may be set in various ways.

As an example, the predetermined condition may be associated with whether a thread including a target chat message has been viewed. Specifically, in response to an interaction with a target chat message generated in the chat room, the user terminal 20 may display a thread including the target chat message and a dependent message for the target chat message. The server 10 may determine whether the user terminal 20 has viewed the thread. In this case, the server 10 may determine that a chat message (target chat message) included in the thread viewed by the user terminal 20 satisfies the predetermined condition.

As another example, the predetermined condition may be associated with the number of viewers of the thread including the target chat message. Specifically, the server 10 may determine the number of viewers of the thread. The server 10 may determine whether the number of viewers of the thread satisfies the predetermined condition. For example, when there are 100 or more users viewing the thread, the server 10 may determine that the chat message included in the thread satisfies the predetermined condition. In contrast, the server 10 may determine the number of viewers of the thread. For example, when the number of viewers of the thread is greater than or equal to 1,000, the server 10 may determine that the chat message included in the thread satisfies the predetermined condition.

As yet another example, the predetermined condition may be associated with whether a new dependent message is generated for the target chat message. Specifically, the server 10 may identify that a new dependent message is generated for the chat message. The server 10 may determine whether a predetermined condition associated with the generation of a new dependent message is satisfied. For example, when a new dependent message is generated, the server 10 may determine that the base message (chat message) of the new dependent message satisfies a predetermined condition for one minute.

As yet another example, the predetermined condition may be associated with the activity level of a dependent message for the target chat message. The activity level may be determined based on at least one of (i) the number of dependent messages for the target chat message, and (ii) a time at which each of the dependent messages for the target chat message is generated. Specifically, the server 10 may determine whether the number of dependent messages generated during a predetermined time satisfies a predetermined condition. For example, when 10 or more dependent messages are generated for a specific chat message within one minute, the server 10 may determine that the chat message satisfies a predetermined condition.

As yet another example, a predetermined condition may be associated with reactions to the target chat message. Specifically, the server 10 may determine the number of reactions to a chat message generated in the chat room. The server 10 may determine whether the number of reactions to a target chat message satisfies a predetermined condition. For example, the predetermined condition may be that the number of reactions is greater than or equal to 100. In this case, if the number of reactions to the target chat message is greater than or equal to 100, the server 10 may determine that the target chat message satisfies the predetermined condition.

In contrast, the predetermined condition may be a chat message with the highest number of reactions among the chat messages displayed in the chat room of the user terminal 20. For example, when there are five chat messages displayed in the chat room of the user terminal 20 (chat messages displayed on the user screen without scrolling up), the chat message receiving the highest number of reactions among the five chat messages may be determined to satisfy a predetermined condition.

As yet another example, the predetermined condition may be associated with a reaction index of an account that generated the target chat message. The reaction index may be determined based on at least one of (i) dependent messages for chat messages previously generated by a specific account and (ii) reactions to the chat messages previously generated by the specific account. Specifically, the server 10 may determine the reaction index of the specific account. For example, the server 10 may determine the reaction index of the specific account based on the number of friends or follows of the specific account, and the number of dependent messages or reactions associated with chat messages generated by the specific account, and the like. Then, the server 10 may determine whether the reaction index satisfies the predetermined condition.

As yet another example, the predetermined condition may be associated with the permission to generate chat messages (or a dependent message). Specifically, different permissions to generate messages may be applied in the chat room. The server 10 may determine that a predetermined condition is satisfied only in a chat room in which different permissions to generate messages are assigned to participants. For example, in a chat room where all users are allowed to generate chat messages, any chat message generated may be determined not to satisfy a predetermined condition. However, at least some of the chat messages generated in a chat room where only an operator or authorized users are allowed to generate chat messages (for example, chat messages generated by pre-specified users) may be determined to satisfy a predetermined condition.

A selected dependent message corresponding to a target chat message may be at least one of the dependent messages dependent on the target chat message. The selected dependent message may be determined based on the reactions to the dependent messages. For example, a dependent message having the highest number of positive reactions (like reactions) among the dependent messages may be determined as the selected dependent message.

The server 10 may provide the selected dependent message corresponding to the target chat message. Specifically, providing the selected dependent message corresponding to the target chat message may involve displaying the selected dependent message in proximity to the target chat message. For example, providing the selected dependent message corresponding to the target chat message may involve displaying the selected dependent message beneath the target chat message in a comment-like format.

The server 10 may provide information on the number of viewer of the thread through the chat room. Specifically, when it is determined that a predetermined condition associated with the number of viewers is satisfied, the server 10 may provide information on the number of viewers through the chat room. As an example, the predetermined condition associated with the number of viewers may be that the number of viewers is greater than or equal to 100. In this case, when the number of viewers of the thread including the target chat message is 173, the server 10 may display, along with the target chat message, a notification message such as “173 people are currently participating in this thread .” This notification message may be provided even if predetermined condition is not satisfied (e.g., if the thread has viewers less 100).

The server 10 may provide information associated with the generation of a new dependent message through the chat room. Specifically, when it is determined that a new dependent message is generated for a target chat message, the server 10 may provide, through the chat room, information associated with the generation of the new message. For example, when it is determined that a new dependent message is generated, the server 10 may provide a notification message such as “A new thread message is generated.” Thes notification message may be provided for a predetermined period of time (e.g., one minute).

In some cases, there may be a plurality of chat messages that satisfy the predetermined condition. In this case, the server 10 may provide a plurality of selected dependent messages corresponding to a plurality of target chat messages.

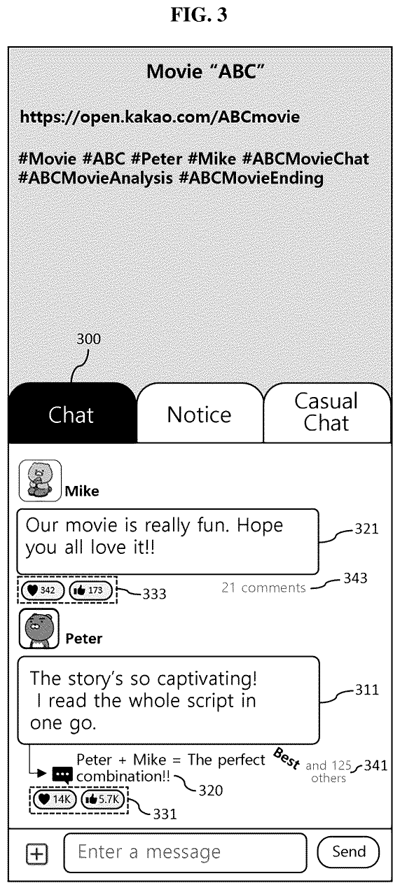

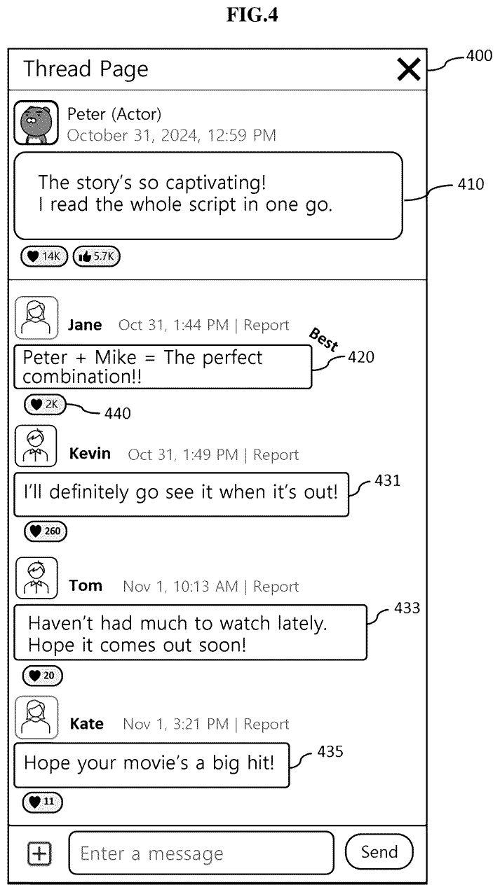

Hereinafter, an example of a method for displaying a selected dependent message on the user terminal 20 will be described with reference to FIGS. 3 to 7.

FIG. 3 illustrates a screen displaying a target chat message 311 and a selected dependent message 320 on the user terminal 20 according to an embodiment of the present disclosure.

Referring to FIG. 3, the user terminal 20 may display a plurality of chat messages 311 and 321 through the “Discussion” chat room 300. When the chat message 311 satisfies a predetermined condition, the user terminal 20 may display a selected dependent message 320 corresponding to the chat message 311.

Specifically, the user terminal 20 may display the chat message 311 generated by Peter and the selected dependent message 320 corresponding to the chat message 311. However, the user terminal 20 may only display a chat message 321 generated by Mike, without displaying any selected dependent message for the chat message 321. This may be the case when only the chat message 311 generated by Peter satisfies the predetermined condition associated with chat messages.

For example, the predetermined condition may be that the number of reactions to a chat message is greater or equal to a predetermined threshold. Specifically, the predetermined condition may be that the number of reactions is greater than or equal to 1,000. In this case, since the number of reactions 331 to the chat message 311 generated by Peter is greater than 1,000, the selected dependent message 320 may be displayed together with the chat message 311. However, since the number of reactions 333 to the chat message 321 generated by Mike is less than 1,000, the selected dependent message may not be displayed together.

In addition, the predetermined condition may be a chat message having the highest number of reactions among the chat messages 311 and 321 displayed on the user terminal 20. Specifically, the user terminal 20 may display, through the chat room, the chat message 311 generated by Peter and the chat message 321 generated by Mike. Since the number of reactions 331 to the chat message 311 generated by Peter is greater than the number of reactions 333 to the chat message 321 generated by Mike, the selected dependent message 320 may be displayed only together with the chat message 311.

Alternatively, the predetermined condition may be associated with the number of dependent messages for a chat message. For example, the predetermined condition may be that the number of dependent messages for a corresponding chat message is greater than or equal to 100. In this case, the chat message 311 generated by Peter has 125 dependent messages, as indicated by reference numeral 341, while the chat message 321 generated by Mike has 21 dependent messages, as indicated by reference numeral 343. Accordingly, the selected dependent message 320 may be displayed only together with the chat message 311.

FIG. 4 illustrates a screen displaying a thread 400 including a target chat message 410 and a selected dependent message 420 on a user terminal 20 according to one embodiment of the present disclosure.

The screen shown in FIG. 4 may be displayed in response to an interaction with at least one of a target chat message 311, a selected dependent message 320, and the number of dependent messages 341 in FIG. 3.

Referring to FIG. 4, the user terminal 20 may display the thread 400. The thread 400 may refer to a continuous set of messages including a chat message (base message) and dependent messages therefor. For example, the thread 400 may be a set of reply messages, comment messages, and the like. for the chat message serving as a base message.

The thread 400 may include a target chat message 410, a selected dependent message 420, and dependent messages 431, 433, and 435 for the target chat message 410. As an example, the dependent messages 420, 431, 433, and 435 may be threaded messages for the target chat message 410.

In general, the dependent messages 420, 431, 433, and 435 may be provided through the thread 400. However, when the dependent message 420 satisfies a predetermined condition, as shown in FIG. 3, the dependent message 420 may be determined as the selected dependent message 420 and provided through the chat room.

The selected dependent message 420 may be at least one of the dependent messages for the target chat message 410. Unlike the example shown in FIG. 4, there may be a plurality of selected dependent messages.

The selected dependent message 420 may be determined based on the reactions 440 to the dependent message 420 for the target chat message 410. For example, the selected dependent message 420 may be the one having the highest number of positive reactions among the dependent messages 420, 431, 433, and 435.

FIG. 5 illustrates a screen displaying chat messages 511, 513, and 515 through a second-type chat room 503 on a user terminal 20 according to one embodiment of the present disclosure.

Referring to FIG. 5, chat rooms may be classified into various types. Specifically, the chat room types may be classified into a first-type chat room 501 configured to provide dependent messages in response to chat messages and a second-type chat room 503 not configured to provide dependent messages in response to chat messages. The dependent message may include a reaction.

In some cases, as shown in FIG. 5, the second-type chat room 503 may generate only reactions among dependent messages and may not generate comment or reply messages. For example, the “Discussion” chat room 501 may be a first-type chat room configured to provide a dependent message 320 for a chat message 311, as shown in FIG. 3. However, the “Notice” chat room 503 may be a second-type chat room not configured to provide dependent messages (excluding reactions) for chat messages 511, 513, and 515, as illustrated in FIG. 5.

Whether a chat room is a first-type or second-type chat room may be determined in various ways. For example, the server 10 may receive information on a type of chat room from the terminal of an operator who creates the chat room.

In contrast, the server 10 may determine a type of chat room depending on whether a predetermined condition is satisfied. Specifically, the server 10 may determine that a chat room is a first-type chat room when permissions to generate messages differ among participants, and a second-type chat room when identical permissions to generate messages are given to all participants.

In some cases, the type of chat room may be changed by the operator terminal (or server) of the chat room after the chat room is generated.

When the chat room is a second-type chat room, a selected dependent message may not be displayed for a target chat message even if the predetermined condition is satisfied.

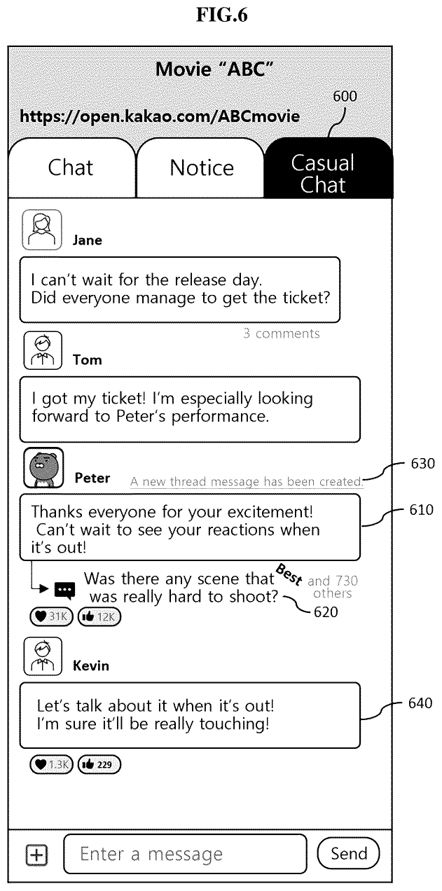

FIG. 6 illustrates a screen displaying information 630 associated with the generation of a new dependent message on a user terminal 20 according to an embodiment of the present disclosure.

Referring to FIG. 6, when a target chat message 610 satisfies a predetermined condition, the user terminal 20 may display a selected dependent message 620 corresponding to the target chat message 610. The predetermined condition may be set in various ways.

For example, the predetermined condition may be associated with a reaction index of a user account that generated the target chat message 610. Specifically, the server 10 may determine a reaction index for Peter's account based on the number of friends, the number of follows, the number of dependent messages, and the number of reactions associated with chat messages generated by Peter's account. Thereafter, when the reaction index satisfies the predetermined condition, the chat message 610 generated by the Peter account may be determined to satisfy the predetermined condition.

As another example, the predetermined condition may be associated with chat messages generated by a specific user account. Specifically, the server 10 may determine a target chat message only from among chat messages generated by the specific user account. For example, the server 10 may determine that at least some messages (e.g., the chat message 610) of the chat messages generated by Peter satisfy a predetermined condition. In this case, both the chat message 610 generated by Peter and the chat message 640 generated by Kevin may each have the number of reactions greater than or equal to 1,000, satisfying the predetermined condition. However, the chat message 610 generated by Peter may be determined as a target chat message that satisfies the predetermined condition, whereas the chat message 640 generated by Kevin may not be determined as a target chat message. In this case, only the chat message 610 generated by Peter may be determined to satisfy the predetermined condition. This may occur in a many-to-one chat room between a specific actor or celebrity and other participants.

As yet another example, the predetermined condition may be associated with a permission of the account that generated the chat message. Specifically, different permissions may be assigned to the accounts participating in the chat room 600. For example, Jane, Tom, and Kevin may are assigned with regular-user permissions to generate messages in the chat room 600. However, Peter may be assigned with a manager, operator, or administrator permission to generate messages in the chat room 600. In this case, when a chat message is generated by Peter who is a manager, operator, or administrator of the chat room, the server 10 may determine that the predetermined condition is satisfied.

As yet another example, the predetermined condition may be associated with the generation of a new dependent message for the target chat message 610. Specifically, the server 10 may identify a new dependent message generated for a target chat message. In this case, the server 10 may determine that the chat message for which the new dependent message is generated satisfies the predetermined condition for a predetermined period of time. For example, when a new dependent message is generated for the target chat message 610, the server 10 may determine that the target chat message 610 satisfies the predetermined condition for one minute.

When the server 10 identifies the new dependent message generated for the target chat message 610, the server 10 may provide information 630 associated with the generated of the new dependent message through the chat room 600. For example, the information associated with the generation of a dependent message may be a notification message 630 such as “A new thread message is generated.” In some cases, the information 630 associated with generation of a new dependent message may be displayed only while the predetermined condition is satisfied. For example, once a new dependent message is generated, the server 10 may determine that the target chat message 610 satisfies the predetermined condition for one minute. In this case, the information 630 associated with the generation of the dependent message may only be displayed for one minute.

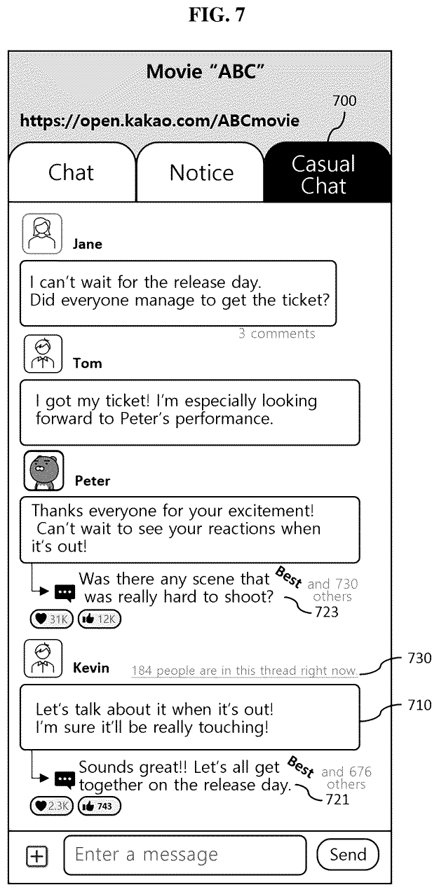

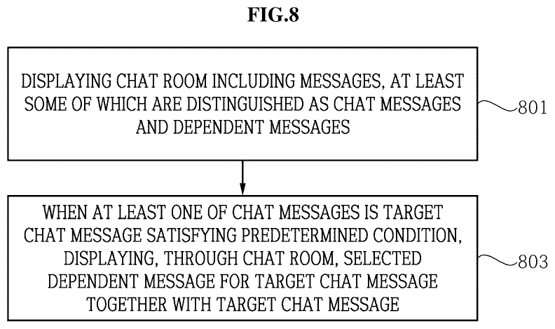

FIG. 7 illustrates a screen in which the user terminal 20 according to an embodiment of the present disclosure displays information 730 on the number of viewers.

Referring to FIG. 7, when a target chat message 710 satisfies a predetermined condition, the user terminal 20 may display a selected dependent message 721 corresponding to the target chat message 710. The predetermined condition may be associated with the number of viewers of a thread including the target chat message 710. Specifically, the server 10 may determine the number of viewers of the thread including the target chat message 710 and the selected dependent message 721. The server 10 may determine whether the number of viewers of the thread satisfies the predetermined condition. For example, when there are 100 or more viewers of the thread, the server 10 may determine that the chat message 710 included in the thread satisfies the predetermined condition.

In addition, although not shown in the drawings, the server 10 may determine whether the number of viewers of the thread satisfies the predetermined condition. For example, when the total number of viewers of the thread after the creation of the thread is greater than or equal to 1,000, the server 10 may determine that the chat message 710 included in the thread satisfies the predetermined condition.

When it is determined that the predetermined condition associated with the number of viewers is satisfied, the server 10 may provide the information 730 on the number of viewers through the chat room 700. For example, the information on the number of viewers may be a notification message 730 such as “184 people are currently participating in this thread.” In some cases, the information 730 on the number of viewers may be displayed only while the predetermined condition is satisfied. For example, when the number of viewer of the thread is less than 100, the server 10 may not provide the information 730 on the number of viewers of the thread.

As illustrated in FIG. 7, the user terminal 20 may display a plurality of target chat messages and a plurality of selected dependent messages that satisfy a predetermined condition. For example, both a chat message by Peter and a chat message by Kevin may be target chat messages that satisfy the predetermined condition. In this case, the user terminal 20 may display selected dependent messages 721 and 723 corresponding to each chat message.

Although not illustrated in the drawing, the user terminal 20 may display the plurality of selected dependent messages corresponding to the target chat message 710 that satisfies a predetermined condition. That is, the plurality of selected dependent messages may be provided corresponding to a chat message.

FIG. 8 is a flowchart illustrating a method for displaying a selected dependent message by the user terminal 20 according to an embodiment of the present disclosure.

For convenience of explanation, the description of operations in FIG. 8 that are substantially the same as those in FIG. 2 may be replaced with the description referring to FIG. 2.

In operation 801, the user terminal 20 displays a chat room including messages, at least some of the messages being distinguished as chat messages and dependent messages. Since operation 801 is identical to operation 201 of FIG. 2, the description of operation 801 is replaced with the description of operation 201 of FIG. 2.

In operation 803, when at least one of the chat messages satisfies a predetermined condition, the user terminal 20 displays, through the chat room, a selected dependent message for a target chat message together with the target chat message. Since operation 803 is identical to operation 203 of FIG. 2, the description of operation 803 is replaced with the description of operation 203 of FIG. 2.

In the present disclosure, it is possible to provide a selected dependent message among dependent messages for a specific chat message through a chat room, thereby facilitating identification of reactions from other users to the specific chat message.

In the present disclosure, it is possible to provide a chat room in which many-to-one conversations mainly occur between a specific person and a plurality of participants, thereby facilitating identification of the reactions of the plurality of participants.

The technical features disclosed in each embodiment of the present disclosure are not limited to the corresponding embodiment, and, unless mutually incompatible, may be combined with features of other embodiments.

Accordingly, although each embodiment has been described focusing on its own technical features, the respective features may nevertheless be applied in combination with other features as long as they are not mutually incompatible.

The present disclosure is not limited to the above-described embodiments and the accompanying drawings, and various modifications and variations can be made by those skilled in the art. Therefore, the scope of the present disclosure is to be defined not only by the claims but also by equivalents thereof.

What is claimed is:

1. A method for providing a selected dependent message by a server, the method comprising:
providing, to a user terminal, a chat room in which messages are generated, at least some of the messages being distinguished as chat messages and dependent messages, wherein the dependent messages are dependent on one of the chat messages that serves as a base message;
when at least one of the chat messages is a target chat message satisfying a predetermined condition, providing, through the chat room, a selected dependent message corresponding to the target chat message;
receiving, from the user terminal, an interaction with at least one of the target chat message and the selected dependent message; and
providing, to the user terminal, a thread comprising the target chat message and the selected dependent message through an object that is distinct from the chat room.

2. The method of claim 1, wherein the dependent messages are threaded messages comprising content written by creators of the dependent messages.

3. The method of claim 1, wherein the predetermined condition is associated with whether the user terminal has viewed the thread.

4. The method of claim 1, wherein the predetermined condition is associated with the number of viewers of the thread.

5. The method of claim 4, further comprising, in response to determining that the predetermined condition associated with the number of viewers is satisfied, providing information on the number of viewers through the chat room.

6. The method of claim 1, further comprising, in response to determining that a new dependent message is generated for the target chat message, providing information associated with the generation of the new dependent message through the chat room.

7. The method of claim 1, wherein the predetermined condition is associated with generation of a new dependent message for the target chat message.

8. The method of claim 1, wherein:
the predetermined condition is associated with an activity level of the dependent messages for the target chat message, and
the activity level is based on at least one of (i) the number of the dependent messages for the target chat message, and (ii) a time at which each of the dependent messages for the target chat message is generated.

9. The method of claim 1, wherein the predetermined condition is associated with reactions to the target chat message.

10. The method of claim 1, wherein:
the predetermined condition is associated with a reaction index of an account that generated the target chat message, and
the reaction index is based on at least one of (i) dependent messages for chat messages previously generated by the account and (ii) reactions to the chat messages previously generated by the account.

11. The method of claim 1, wherein the predetermined condition is associated with whether different permissions to generate messages are assigned to participants in the chat room.

12. The method of claim 1, wherein the predetermined condition is associated with a permission of the account that generated the chat message.

13. The method of claim 1, wherein:
the selected dependent message is at least one of the dependent messages for the target chat message, and
the selected dependent message is determined based on reactions to the dependent messages for the target chat message.

14. The method of claim 1, wherein:
the chat room is classified as a first-type chat room configured to provide a dependent message corresponding to a chat message or a second-type chat room not configured to provide a dependent message corresponding to a chat message, and
the method further comprises receiving information on a type of the chat room from an operator terminal of the chat room.

15. A server for providing a selected dependent message, comprising:
a memory storing instructions, and
a processor configured to execute instructions to:
provide, to a user terminal, a chat room in which messages are generated, at least some of the messages being distinguished as chat messages and dependent messages, wherein the dependent messages are dependent on one of the chat messages that serves as a base message;
when at least one of the chat messages is a target chat message satisfying a predetermined condition, provide, through the chat room, a selected dependent message corresponding to the target chat message;
receive, from the user terminal, an interaction with at least one of the target chat message and the selected dependent message; and
provide, to the user terminal, a thread comprising the target chat message and the selected dependent message through an object that is distinct from the chat room.

16. A method for displaying a selected dependent message by a user terminal, comprising:
displaying a chat room comprising messages, at least some of the messages being distinguished as chat messages and dependent messages, wherein the dependent messages are dependent on one of the chat messages that serves as a base message;
when at least one of the chat messages is a target chat message satisfying a predetermined condition, displaying, through the chat room, a selected dependent message corresponding to the target chat message together with the target chat message;
receiving an interaction with at least one of the target chat message and the selected dependent message; and
displaying a thread comprising the target chat message and the selected dependent message through an object that is distinct from the chat room.
